(19) United States
(12) Patent Application Publication
(10) Pub. No.: US 2002/0017222 A1
(43) Pub. Date: Feb. 14, 2002

(54) Strengthened, light weight construction board

(76) Inventor: Joseph S. Luongo, Kingman, AZ (US)

Correspondence Address: WHITEFORD, TAYLOR & PRESTON, LLP, ATTN: GREGORY M STONE, SEVEN SAINT PAUL STREET, BALTIMORE, MD, 21202-1626, US

(21) Appl. No.: 09/828,994

(22) Filed: Apr. 9, 2001

Related U.S. Application Data
(63) Continuation-in-part of application No. 09/732,852, filed on Dec. 8, 2000.
Application No. 09/732,852 is a continuation-in-part of application No. 09/547,615, filed on Apr. 12, 2000.
Application No. 09/547,615 is a continuation-in-part of application No. 09/471,448, filed on Dec. 23, 1999.
Application No. 09/471,448 is a continuation-in-part of application No. 09/374,589, filed on Aug. 13, 1999, now Pat. No. 6,251,979.
Application No. 09/471,448 is a continuation-in-part of application No. 09/195,438, filed on Nov. 18, 1998, now abandoned.
(60) Provisional application No. 60/139,618, filed on Jun. 17, 1999.

(51) Int. Cl. C04B 11/00; C04B 12/04

(52) U.S. Cl. 106/611; 106/631

(57) ABSTRACT

A novel construction board composition is disclosed comprising a unique combination of synthetic binders selected for their ability to establish a strengthened permanent bond in the final dry state for use in a construction board composition comprising primarily gypsum, and in a construction board composition comprising an expanded mineral such as Perlite which largely reduces the amount of gypsum over current gypsum construction board formulations, thus reducing the weight while maintaining the strength of the construction board structure. In a preferred embodiment, the lightweight, strengthened gypsum construction board of the present invention also comprises an optional covering veneer that is applied to provide increased strength, moisture resistance, and fire retardency, and the back paper top ply is treated to provide increased flexural strength.

### CROSS-REFERENCE TO RELATED APPLICATIONS

The present application is a Continuation-in-Part Application of copending U.S. Pat. application Ser. No. 09/732,852, filed Dec. 8, 2000, which application is a Continuation-in-Part of U.S. patent application Ser. No. 09/547,615, filed Apr. 12, 2000, which application is a Continuation-in-Part application of copending U.S. patent application Ser. No. 09/471,448, filed Dec. 23, 1999, which application is a Continuation-in-Part Application of copending U.S. patent application Ser. No. 09/374,589, filed Aug. 13, 1999, which application is based upon and gains priority from U.S. Provisional Pat. application Ser. No. 60/139,618, filed Jun. 17, 1999 by the inventor herein and entitled “Improved Wallboard and Method and Apparatus for Making the Same,” and which application is also a Continuation-in-Part application of U.S. patent application Ser. No. 09/195,438, filed Nov. 18, 1998 by the inventor herein and entitled “Light Weight Fire and Moisture Resistant Wallboard.”

### BACKGROUND OF THE INVENTION

1. Field of the Invention

This invention relates to new compositions that are useful in the manufacture of boards or panels for use in construction applications. More particularly, this invention is directed to a novel construction board or panel composition comprising a unique combination of synthetic binders selected for their ability to establish a strengthened permanent bond in the final dry state, in combination with gypsum and an expanded mineral such as Perlite. Utilizing such synthetic binders provides an increased strength to the construction board core, enabling lighter-weight Perlite to replace at least a portion of the heavier gypsum traditionally used in construction board compositions. Moreover, the synthetic binders disclosed herein uniquely cross-link with the expanded mineral to form a much stronger bond between the constituent components of the construction board core material than that which has been available in previously known construction board products. In a preferred embodiment, the lightweight, strengthened construction board of the present invention also comprises a covering veneer of paper or fiber that is treated to further the fire retardant and moisture resistance of the product. Additionally, this invention relates to the unique manufacturing process to produce the construction board composition of the present invention in order to create a lightweight, strengthened, moisture resistant, and fire retardant panel to be used in construction applications.

2. Description of the Background

It is well known in the art to use planar panels or sheets formed from inorganic materials in the construction of walls, ceilings, floors, exterior sheathing, and similar construction elements, instead of applying wet plaster to such surfaces. Such panels may be applied to stud work comprising the walls, ceilings, floors, and exteriors of building structures in the form of wallboard, lath, sheathing, and the like, using nails, screws, or other fastening means. The use of calcium sulfate hemihydrate CaSO₄.2H₂O in the manufacture of such construction panels has predominately been unchanged for over half a century. In general, these panels comprise essentially a core of set interlaced gypsum crystals disposed between fibrous, especially paper, liner sheets. After the gypsum slurry has set (i.e., reacted with the water from the aqueous slurry) and dried, the sheet is cut into standard board sizes.

Unfortunately, however, traditional gypsum construction boards can be quite heavy, causing quick fatigue to installers and delayed construction schedules, as well as large transportation costs. Likewise, traditional construction boards often realize significant increases in weight when particular construction applications require stronger construction panels, thus making their use even more problematic.

Attempts to modify the composition of traditional gypsum panels in order to provide a lighter weight construction panel have been made, but with little success or commercial viability. For example, the addition of synthetic binders has very recently been attempted as disclosed in U.S. Pat. No. 5,879,825 to Burke et al.; however, the engineering and chemical research in various combinations of complex chemical formulations and combinations thereof has been quite limited. Additionally, Burke et al. fails to address the environmental concerns of noxious fumes under fire engineering standard ASTM testing E119. Still further, cost considerations limit the amount of acrylic polymer present in the Burke et al. composition to 1 to 2 percent, but the fact that such acrylic polymer in Burke et al. employs a less than 10% solids ratio results in a polymer having a minimal cross-linking performance with the other constituent elements. Further, while the use of Perlite as an antidessicant to prevent the dehydration of gypsum crystals formed during setting of the core composition is disclosed, no consideration is given to introducing an expanded mineral, such as perlite, as a substitute for gypsum as one of the structural foundations of the board core and as a strengthening agent when combined with appropriate other constituent elements (as set forth below), nor the specific need for a synthetic binder composition for establishing a complete cross-linking between the constituent elements of the core in order to create a molecular change within the strengthening agent, which molecular change is in turn required to completely bond a reduced amount of gypsum with the other components of a construction board core.

It would therefore by highly advantageous to provide an improved, high strength, lightweight construction panel product which reduces the need for gypsum in the panel composition by means of displacing some of the normal amount of gypsum utilized with the expanded mineral perlite, and which utilizes a synthetic binder composition that enables a complete cross-linking of the constituent elements of the lighter construction panel core to form a rigid structure with the structural integrity to withstand the structural requirements of traditional construction panels. Such construction panels should meet industry requirements, and likewise have a strength at least equal to previously known construction panels while reducing the weight of the finished panel.

### SUMMARY OF THE INVENTION

It is therefore an object of the instant invention to provide an improved, light weight, strengthened gypsum construction board product that overcomes the disadvantages of the prior art.

This and other objects are achieved through a composition consisting essentially of a unique combination of synthetic binders selected for their ability to establish a permanent bond in the dry state, combined with an expanded mineral (e.g., Perlite and crushed Perlite), organic binding adhesives, drying agents, crystal growth enhancers, and gypsum with a sufficient amount of water to form an aqueous slurry, all contained within a covering of treated moisture and heat resistant paper material, which produces an improved lighter-weight, strengthened gypsum construction board product. The technology of the present invention utilizes an expanded mineral which fuses with the calcined gypsum mineral and physically becomes part of the composite matrix due to the complex formulation of binders and gypsum attaching themselves to the expanded mineral, instead of the expanded mineral only acting as a filler.

Perlite (expanded) can be graded by density in pounds per cubic foot, and classified by product number or trade name for producer and user identification. The expanded product can weigh as little as 2 pounds per cubic foot, but the most widely used bulk-density grade range is from 7 to 15 pounds per cubic foot. The range of expanded Perlite utilized in the construction board composite core of the present invention is 4 to 10 pounds per cubic foot, with 4 pounds per cubic foot being preferred. It has been found that the more friable cryogenic and micro-sphere grades in the 3 to 4 pound range are favorable, with 4 pounds being the most preferred, over the heavier grades ranging from 5 to 10 pounds per cubic foot. Grades typical to this heavier range include concrete, plaster, and cavity fill or masonry, which can also be utilized, but are not as preferable as the lighter previously mentioned grades. The particle size ranges from 100 to 2,000 microns, and preferably from 200 to 1000 microns. Preferably, the expanded Perlite will have a particle size ranging from no larger than 10 mesh sieve size and no smaller than 200 mesh sieve size measured on standard screen scale. The particle size of the preferred expanded Perlite is directly related to the strength of the construction board core in the aspect of fusion. Particles that are too large tend to space gypsum crystal growth too far apart, and particles that are too small do not allow enough area for the gypsum crystal to fuse onto. The particle size is not directly related to the expansion method but can be controlled by means of properly sizing the Perlite ore prior to expansion.

It was determined to be advantageous to use a polyvinyl acetate emulsion or vinyl acetate homopolymer emulsion or water based non-V.O.C. acrylic or polyurethane emulsion for use in the binder of the instant invention. While vinyl acetates of all types were found to be less costly and performed well, vinyl acetate emulsions with 0.10% to 30% polyvinyl alcohol were further preferred and found to provide unforeseen benefits over powdered polyvinyl acetates. First, vinyl acetate emulsions containing polyvinyl alcohol are available at far less cost (approximately one third) than powdered polyvinyl acetates. Further, vinyl acetate emulsions when properly added and diluted for quick dispersion in the metered water or water solution feeds, prior to entrance into the gypsum slurry mixer, dispersed and performed better than powdered polyvinyl acetates, thus simplifying the manufacturing process and reducing costs caused by flawed boards. Better results in terms of reactivity, dispersion, and ease of mixing occurred in test samples when the vinyl acetate emulsions were strengthened and stabilized with polyvinyl alcohol. It was discovered that the optimum molecular weight of the preferred polyvinyl alcohol selected to strengthen and stabilize the vinyl acetate emulsion is a function of the type of gypsum stucco prepared, and the length of time the final vinyl acetate emulsion needed to be stabilized. In final prepared gypsum stuccos that had higher percentages of certain clays (i.e., above 1% of clays commonly found in some gypsum deposits) naturally occurring in or with the gypsum ore, lower molecular weight polyvinyl alcohols, preferably between 20 and 5000, exhibited better results with less initial thickening of the wet gypsum slurry mix.

It has also been determined that the addition of small amounts of accelerators or strengthening agents described below can be added to the final polyvinyl acetate emulsion to increase strength and final composite set performance. To describe this macroscopically, the binder is diluted in the processed water to disperse throughout the wet gypsum and perlite slurry in the pin mixer. An accelerator or strengthening agent is added to the back side of the gypsum slurry pin mixer, to begin to chemically increase the set of the binder once the formed construction board is proceeding downstream to the rotary knife. Optimally, the initial set time of the board is decreased such that the board can be cut in less time. Thus, the board line can be run faster, producing more construction board in a shorter period of time. Potassium or other alkali elements or compounds can be added at 0.001% to 3% of the total board wet weight at the last stages to increase the rate of the set time of the binder and ultimately decrease the initial set of the construction board. While Potassium Sulfate has been utilized to decrease the initial set time of the green construction board prior to the knife, too high or too small amounts can actually burn the gypsum crystals and create a “punky” or powdery final construction board that has lost its strength. The binder (vinyl acetate emulsion, or water based non V.O.C. acrylic or polyurethane emulsion) reacts with the accelerator (potassium sulfate) to retard or even eliminate the burning of the gypsum crystals.

It has also been found that certain organic polymers, including aniline formaldehyde resins, melamine formaldehyde resins, urea-formaldehyde resins, and urea-melamine formaldehyde resins, may be combined with polyvinyl acetate or polyvinyl alcohol to provide an alternative binder capable of fully crosslinking with the inorganic minerals of the composition in order to form a strengthened composite core for a construction board.

Optionally, reinforcing fibers, fire retardants, water repellents, and other water proofing materials may be part of the composition. More particularly, current gypsum construction board core formulations, once dried, have common micro-cracks, form more brittle core composites, and exhibit less tolerant processed board flexibility. Paper fibers, or other synthetic fibers, have been utilized more in the past to hold the core composite together, yet have been insufficient to stop board drying over time, and increase short and long term micro-cracking and ultimate core breakdown or spot load failure. Thus, the development of the synthetic adhesive technology of the instant invention has developed critical improvements to board flexibility, moisture retention, and long term, sustained and improved strength.

Actual plant manufacturing test runs of the construction board compositions described herein were conducted for several hours each, and using a variety of gypsum ore and gypsum stucco preparation methods. The test runs showed improved ASTM test results at each run. The process of introducing and adding sufficient amounts of the synthetic binder into the final gypsum stucco was successfully completed during each test run. However, improved results occurred when the binder was diluted in the metered water or other prepared water solutions, for direct feed prior to the gypsum slurry mixer. Higher ASTM lab test results occurred when utilizing the optimum design combinations and percentages set forth in the examples below of vinyl acetate and water based non-V.O.C. acrylic or polyurethane emulsions, with each particular type of gypsum stucco supplied during the test runs. Thus, by optimizing the final polyvinyl acetate homopolymer or water based non-V.O.C. acrylic or urethane polymer emulsion, optimum test results were achieved in both the test lab and in actual manufacturing test samples.

Thus, the test run results showed that the construction board composition of the instant invention provides a number of benefits over previously known construction board products.

First, the present invention allows for a construction board composition that is significantly lighter in weight (up to fifty percent lighter) than current traditional heavy gypsum construction board formulations. This reduced weight also results in transporting lighter loads, in turn reducing transportation costs. Further, job site labor costs are reduced by enabling the workers to handle lightened loads, such that the installation process is made easier and less costly. Similarly, the potential for heavy board related injury accidents to the tradesmen that install the construction board product is reduced.

Further, the construction board composition of the instant invention exhibits equal or greater strength than current heavy gypsum construction board, with improvements in moisture resistance and flame resistance that exceeds current industry standards. This lightweight and strength factor equates to decreased structural support load bearing and lessens the total support strength required in any project, in turn further reducing overall construction costs.

Yet another benefit of the strengthened construction board of the instant invention is the reduction in the amount of board breakage (and in the amount of airborne particulates associated with such breakage) and losses due to manual or machine transport to the installation site, due to the fact that the composition of the instant invention provides the construction board with greater flexibility than has been known in previous construction board compositions.

Yet another benefit of the composition utilized in the instant invention is the “clean-snap” characteristics exhibited by a finished construction board when the board is cut with a utility knife. The attempted addition of synthetic binders in the past to construction board compositions have reduced the ability to cut the finished construction board sheet during installation with a utility knife. However, the composition of the instant invention was developed after extensive testing and analysis of numerous chemical combinations, with extensive chemical technical research and testing to realize a brittle cross-linking complex polymer that combines and fuses with the mineral and expanded mineral, that is easily cut and snapped with a utility knife as applied in standard construction industry use.

The specific binders described below as a constituent element of the compositions used herein also provide specific benefits related to the characteristics and manufacturing economics of the construction board of the instant invention. Water based vinyl acetate, non-V.O.C acrylic and non-V.O.C. polyurethane emulsions tested were selected and preferred over other petrochemical-based emulsions or liquid plastics for several specific reasons. First, the most crucial practical factors in selecting the preferred type of adhesive are performance of the adhesive in binding the construction board core, and cost relative to that performance, and the compatibility of the particular emulsion with the other specific constituents of the sheathing core.

Such cost factors include both the cost of the base components, such as vinyl acetate monomer (VAM) (which today is preferably produced from ethylene) that make up the adhesive, and the cost to make the final product. It was found that vinyl acetates provide the lowest cost, while water based non-V.O.C. acrylic and polyurethane polymers provided non-toxic and environmentally safe high performance at a slightly higher but not unreasonable cost, while all three maintained assurance of high adherence and coherence capabilities to attach to the minerals in the construction board core, namely, gypsum and/or perlite. Also, a deliberate effort was made to determine and utilize a low cost, final stage, brittle-type plastic in emulsion or liquid initial state, that when hardened would have the ease of a clean snap when cut with a utility knife. It was discovered that the vinyl acetate adhesive family and the non-V.O.C. acrylic and polyurethane families performed superior to sodium silicates in meeting these requirements, even though sodium silicates were lower in overall cost.

Furthermore, it was found that the blending of organic polymers, including aniline formaldehyde resins, melamine formaldehyde resins, urea-formaldehyde resins, and urea-melamine formaldehyde resins, may provide superior adhesion and cohesion properties while enabling an overall lower cost yet fully crosslinking binder. Such blended polymers provide superior crosslinking between the organic and inorganic materials used in the manufacture of construction board.

Regarding the compatibility of the emulsion with the other constituents of the construction board core, test results proved that water solubility of the adhesives and ease of dispersion into the final core composite was crucial to fabricating the construction board without paper blows and peels due to insufficient or improper re-hydration of the calcined gypsum. In all of the tests performed, results showed favorably toward the latex water based emulsions for the best compatibility and ease of dispersion when added into the system with no adverse affect on hydration. The preferred polymer systems of the instant invention provided for complete hydration of the gypsum as well as improving upon the paper to core bond in every instance of its use. The latex water based emulsions also worked best at the drier end of the line (in the kiln) as they didn't react poorly or inhibit evaporation due to filming and/or agglomeration and blistering due to improper dispersion into the slurry.

Also, it was discovered that board flexibility during actual board installation, or during the manufacture of the board as it travels over rollers and curved rises in and out of the drying kilns, was improved through the use of more plastic adhesives (such as vinyl acetate and non-V.O.C. acrylic and polyurethanes) as the binder.

Yet another benefit of the binder formulations utilized in the construction board of the instant invention lies in their ability to easily cross link with the other constituent elements of the formulations provided below. Vinyl acetates were found to react well and cross-link in the presence of boron with starches to create a final tacky binder, at the proper percentages set forth below, that forms a brittle plastic excellent for binding the core of the construction board product in such a way as to maintain superior strength characteristics while reducing the overall weight of the board. Likewise, as mentioned briefly above and as set forth in greater detail below, blended polymers comprising organic polymers (aniline formaldehyde resins, melamine formaldehyde resins, urea-formaldehyde resins, and urea-melamine formaldehyde resins) and inorganic polymers (polyvinyl acetate and polyvinyl alcohol) were found to completely crosslink with the inorganic minerals of the composition to form a strengthened composite core for a construction board.

The improved, strengthened core material of the instant invention also provides increased compression, shear, and tension loading test results in comparison with the conventional non-reinforced gypsum construction board. ASTM Test Standard C79 standard specifications for gypsum construction board require that specimens shall surpass an average surface water absorption of not more than 1.6 g after 2 hours of elapsed time (Section 5.1.7). While gypsum construction board is required to meet the above ASTM standards, moisture resistance and adverse weather conditions have been long-term problems with gypsum board. The improved gypsum board of the instant invention comprises an improved moisture resistant cover and core material that far surpasses ASTM C79-5.1.7. Thus, the present invention improves the structural strength, moisture resistance, and weight factors in the design of a new improved gypsum board to be utilized as a construction material.

Gypsum board manufacturing is a complex process from the collection of the gypsum rock to the production of the completed construction board. However, the improved gypsum construction board product of the instant invention, as described more fully in the examples below, offers yet another benefit over previously known construction board products, in that it provides increased production capacity from a given gypsum supply over traditional gypsum products and methods of manufacture. More particularly, the technology of the present invention allows for decreased set times from the pin mixer to the knife in laboratory testing, which in turn increases boardline manufacturing speeds far beyond what is currently being realized. As manufacturing speeds increase, so does production, enabling greater amounts of construction board to be produced to meet the current demand. This complex formulation of binders can be seen to be utilized in a wide variety of other building materials as well.

Yet another improvement of the gypsum construction board product of the present invention comprises the environmental improvements realized through the use of the specific binders recited herein. Environmental factors must be evaluated when selecting the preferred adhesive, such as noxious fumes emitted in burning test samples and kiln stack emissions while heating and drying the board during the manufacturing process. Plant operational environmental concerns and plant kiln stack emissions are critical factors for manufacturers to consider in evaluating the use of synthetic adhesives. Petrochemical-based acrylics exhibited higher stack emissions, noxious fumes in burn tests, and presented more environmental operational concerns over similar percentages of vinyl acetate emulsions and water based non-V.O.C acrylics and polyurethanes. Further, the specific adhesives used in the construction board product of the instant invention provide a reduced half-life over commonly used adhesives. The adhesives used in the construction board product of the instant invention decompose very quickly and easily. Thus, the improved construction board of the present invention provides a lightweight, strengthened, fire retardant, whitish-covered Perlite and gypsum construction board with environmental improvements that is competitively priced to traditional gypsum construction board products.

### DETAILED DESCRIPTION OF THE INVENTION

The preferred composition of the improved gypsum construction board product of the present invention comprises a binder especially selected for the property of permanent tackiness in the dry state, preferably a self-crosslinking permanently tacky polymer, and more particularly includes a starch, boric acid, vinyl acetate emulsion or water based non-V.O.C. acrylic or polyurethane emulsion, perlite, and gypsum. In an alternate embodiment, such composition includes starch, boric acid, a blend of polyvinyl acetate or polyvinyl alcohol with an organic polymer, and more particularly an amino resin selected from the group consisting of aniline formaldehyde resin, melamine formaldehyde resin, urea-formaldehyde resin, and urea-melamine formaldehyde resin, in combination with perlite and gypsum. It has been found that these combinations (in the proportions set forth below) offer the best results for weight, strength, setting and bond of the construction board core. After applying and analyzing a wide variety of adhesives by themselves and in combination with one another, it was determined that a binder having the composition set forth herein would allow the construction board to perform as closely to what is currently used while adding strength and reducing weight.

The strengthened core of the improved gypsum construction board of the instant invention contains expanded Perlite in the range of 0.5 to 60% volume by weight. The expanded Perlite ranges in sizes from 100 to 2000 microns, and preferably from 200 to 1000 microns. The following is a typical sieve analysis of the preferred grade: 11.5% retained on 16, 39.1% retained on 30, 24.3% retained on 50, 12.9% retained on 100 and 2.8% retained on 200. The preferred grade loose density ±1 pound is 4 pounds per cubic foot and has a compacted density of 5.5 pounds per cubic foot. Hard Perlite ore having a high compaction resistance is a very dense concentric ore located within the inner perlitic dome, while softer, low compaction resistant ores are located in the frothy pumicious outer surface of the perlitic dome and are very friable. The expanded Perlite utilized in the construction board of the instant invention is preferably derived from classical concentric granular ores from the middle of the perlitic dome, which ores are able to achieve densities in the 4 to 8 pound range, in order to minimize the expanded density and weight of the Perlite used in the composition of the instant invention while maximizing its strength. While Perlite has been used in the past in small quantities as a filler or additive in gypsum board compositions, the instant invention utilizes expanded Perlite as part of the composite core, adding strength to the core as the binder grabs onto the Perlite.

The combination of starch, boric acid and vinyl acetate or water based non-V.O.C. acrylic or polyurethane emulsion, or alternately of starch, boric acid and a blend of polyvinyl acetate or polyvinyl alcohol with an organic amino resin, in itself is sufficient to bond the Perlite together in producing the composite core of the instant invention. However, the combination of gypsum and perlite in the formulation of the inproved construction board product of the instant invention, in comparison to other cementious materials, is preferred due to excellent compatibility of the components described herein.

It is important to note that the unique adhesive technology that is described below is completely new and unobvious to the manufacture of construction board products. This process adds a synthetic variable into an already well-used natural adhesive formulation of starch and borate. When starch is treated with borate, interchange linkages are formed throughout the borate anion structure resulting in modifications of the physical properties of the polymer system. The overall result is a binder which, during the construction board manufacturing process, undergoes a chemical change which provides for complete crosslinking between the starch, borate, and synthetic adhesive to form a strengthened web for gripping the gypsum and perlite and forming a rigid core.

Starch and borate are often added to the traditional construction board composition in order to protect the delicate gypsum crystals and to ensure proper crystal growth of the gypsum constituent of the construction board core as the board is heat treated in a drying kiln at extreme temperatures. However, as mentioned above, starch and borate also combine to form a natural adhesive. Traditional gypsum compositions do not utilize an additional binder to give the board strength, but rather rely on gypsum crystal growth brought about by heat treatment of the board in its final manufacturing stage. Thus, traditional gypsum construction board compositions do not rely on the adhesive nature of the combination of starch and borate. Borate is not utilized as a standard constituent in all construction board core formulations in the industry, but is preferred by some and is always added to fire rated board formulations as a fire retardant.

The construction board composition of the present invention, however, does require an additional binder. It has been found that adding another polymer, namely a vinyl acetate emulsion or water based non-V.O.C. acrylic or polyurethane emulsion, or alternately a blend of polyvinyl acetate or polyvinyl alcohol with an organic amino resin, to the starch polymer and boric acid enables a cross-linking to occur between those constituents. By crosslinking the synthetic polymer chain with the starch and borate polymer chain, more extensive chemical changes are brought about. On a molecular scale, the polymer chain branches extend in all directions, attaching to the gypsum and perlite and increasing the overall strength of the board.

Cross-linking of the binder utilized in the present invention with the starch polymer chain is brought about through boron or the use of boric acid. It was originally believed that the commonly used compound boric acid was a sufficient source of boron for the process of the present invention to cross-link the hydroxyl groups of the starch with the vinyl acetate emulsion branch polymer chains. However, large scale test runs of the construction board of the instant invention revealed an occasional high water demand when standard technical grade ortho boric acids were used, especially when introduced into the system in solution as is not uncommon in board production. Laboratory testing revealed that the pH of the boric acid (6.1 in 0.1% solution) and its low molecular weight were causing some fluidity decrease or viscosity increase in slurry formation. In these circumstances, the solution is to replace the boric acid with sodium tetraborate pentahydrate (5 mol) or sodium tetraborate decahydrate (10 mol), the two compounds actually being less costly than the ortho boric acid. The amount of borax or boric acid should be limited in the range of not higher than 0.35% of the total wet weight of the final slurry or more specifically not more than 0.1% of the total amount of synthetic binder utilized (by weight), as it has been found that higher concentrations can cause gelling of the polyvinyl acetate emulsion and affect strength.

The particular type of board starch utilized is yet another important consideration. Starches, or more specifically unmodified cereal flours and modified corn starches, are commonly utilized in gypsum board production to provide a better interface between the paper and the core and to protect the gypsum crystal during drying of the board, as well as to allow for increased paper bond. A large number of starch grades can be utilized from lower grade cereal flour to high grade very thin boiling starches which are acid treated. Gelling and flow properties as well as compatibility are better in the higher-grade starches produced from dent corn. The quantity utilized in standard construction board production can range anywhere from 5 to 12 pounds per thousand square feet (MSF). Typically this range is from 0.20 to 0.50 percent of the wet board weight (MSF). Testing conducted in the laboratory showed better resulting strength development using the formulation of the present invention and starch in the range of 0.30 to 0.75 percent by weight (MSF) in combination with the synthetic binder. Higher grade acid modified starches worked well in combination and to cross-link with the vinyl acetate emulsion. Further testing revealed other types of starches, including oxidized thin boiling starches, worked well if not better than acid modified starches. In some situations, oxidized starches are highly compatible with vinyl acetate emulsions as are acid treated starches. But in situations where the gypsum stucco has clay impurities, the oxidized starch can grab onto the vinyl acetate emulsion and block flocculation of clay particles with the polyvinyl alcohol, virtually eliminating “clay shock” and viscosity problems experienced in formulations where clay shock occurs. Although slightly higher in cost, oxidized starches are believed to be the least expensive and simplest solution in these clay situations. The gelling and fluid characteristics of starch play a larger role in the formulation of the present invention than in standard construction board formulations. Instead of the majority of the starch migrating to the face to protect the core to paper bond, much of the starch is retained in the core to chemically combine with the synthetic additive to fuse the minerals together. This cross-linking of the starch and synthetic additive is key to the strength development of the core of the lightweight construction board of the present invention. In all tests, the higher grades, meaning flash dried, wet milled modified starches gave the best results in nail pull and flexural strength ASTM testing procedures over the lower grade, dry milled, belt dried starches requiring less processing than higher grade starches. The use of more intensely processed starches is somewhat a factor to consider in determining the optimum final construction board costs.

By introducing vinyl acetate, polyvinyl acetate copolymer, a vinyl acetate-ethylene copolymer, a water based non-V.O.C. acrylic or polyurethane polymer, or a blend or polyvinyl acetate or polyvinyl alcohol with an organic amino resin, into the compositions of the construction board of the instant invention, the resultant complex molecule is much larger, extending its various branches in all directions. It is this desirable change in the polymeric structure of the molecule to a more highly branched chain polymer of higher molecular weight that produces an adhesive with increased viscosity, quicker tack, and better fluid properties. These qualities are crucial to the strength of the most preferred embodiment of the invention. Listed below are two main benefits of this polymer adhesive system. First, increased flexural and compressive strength is realized over current gypsum board ASTM standards. Secondly, the unique polymer adhesive composition of the instant invention enables a construction board composition that is up to as much as fifty percent lighter than current gypsum board.

The vinyl acetate emulsion used as the binder in one embodiment of the instant invention produces very favorable test samples and test results. The vinyl acetate emulsion is a milky white liquid, with typical characteristics in the range of a melting point of 32° F. to 39° F., a vapor pressure of 16 mm Hg to 22 mm Hg (68° F. to 70° F.), specific gravity of 1.0 to 2.0, vapor density of from less than 1 to 1, a boiling point of from 212° F. to greater than 212° F., and the emulsion is water miscible.

In general, Vinyl Acetate Polymers (VAP's) such as the vinyl acetate emulsion used in one embodiment of the composition of the instant invention are hard, brittle, yet tough resins which are found overall to be favorable to the board installation process which requires that the construction board have the ability of being cut and cleanly snapped with a common utility knife after the board has been scored. Additionally, each of the various vendor-supplied VAP's that were tested, when combined in the unique percentages of gypsum and perlite samples tested, were found to be environmentally friendly and not noxious during heat testing. Further, each of the VAP formulations available clearly exhibited the cross linking with starch and mineral (through the use of boric acid), whereby a fusion occurred between the minerals and the adhesive composition. It is thus firmly believed that a chemical fusion of organic and inorganic elements in the composition of the instant invention occurs, rather than a mere adherence by the binder to the mineral. Thus, a fusion occurs which results in a chemically changed binder combination which, when heated, in turn chemically fuses the board formulation.

The characteristics of the final vinyl acetate emulsion depend largely on the characteristics of the polyvinyl alcohol used during the manufacture of the emulsion. Wide ranges of polyvinyl alcohols (PVAl's) which can be made are directly dependent upon the characteristics of the intermediate polyvinyl acetate (PVA), especially the PVA's molecular weight and hydrolysis process. PVAl's are generally classified by the percentage of hydrolysis and their degree of polymerization. All polyvinyl alcohols will work in the instant application which are hydrolyzed in preferable ranges from 80 to 100%. Their degree of polymerization based on viscosity at approximately 20° C. of 4% aqueous solution, in the range of 5cP (low viscosity) to 60cP (high viscosity) will work in the application. The degree of polymerization of grades which work are in the range of 500 to approximately 2500. The specific PVAl chosen, including the viscosity of the final polyvinyl acetate emulsion, or the derivative of PVAl chosen, shall be field lab or field trial selected. It is primarily dependent on the chemical composition of the gypsum ore, the chemistry of the metered water, and to a significant extent the overall chemical makeup of the constituent additives together. As the temperature increases in the metered water or plant conditions, solubility increases. The fluidity of the wet gypsum slurry finally produced can be directly effected by the proper selection of the PVAM and the final PVA emulsion. Low molecular weight (ca 70-80%) PVAl hydrolyzed grades dissolve rapidly in water at normal room temperatures. It should be noted that solutions of PVAl's in vinyl acetate emulsions mix and disperse more readily in construction board production. They also perform better against “clay shock,” as discussed elsewhere in this specification. High molecular weight PVAl's (ca 95-100%) hydrolyzed grades will generally exhibit higher tensile strength. Higher molecular weight PVAl's are dissolved by dispersing in cold water and heating to approximately 80-90° C. with stirring. Middle range molecular weight (ca 80-95%) grades through hydrolysis are dissolved through slow addition to cold water with stirring, although the temperature can then be raised to 60-80° C. to hasten the process.

All VAP's including vinyl acetate homopolymers and copolymers tested were found sufficient to cross-link with starch and boric acid and perform quite satisfactorily in construction board applications. VAP emulsions exhibited preferable mixing ease, dilution and dispersion in the metered process water, and into the final wet gypsum slurry. Homopolymer emulsions were found quite favorable due to their lowest cost, their rapid setting speed, their good ability to adhere to difficult surfaces, and their “dried” strength. Emulsion homopolymers and copolymers, containing polyvinyl alcohol (PVAl) at the right percentages and molecular weight tested (as set forth below), increase the adhesion and cohesion strength, and increase the stabilization (thus the site storage ability) of the final vinyl acetate polymer.

Lower molecular weight PVAl's worked better in the presence of sizable clay percentage gypsum ores (i.e., above 1%), to enable initial less thickening of the final wet gypsum with perlite stucco. Higher molecular weight PVAl's increase the absorption of binder molecules onto the particles of the clay minerals or flocculation of clay particles producing in effect “clay shock.” The correction for this phenomenon is to utilize lower molecular weight PVAl's that are partially polymerized and hydrolyzed. Thus in essence, they are less “prepared” PVAl's. Partly hydrolyzed grade PVAl's such as GL-02 polyvinyl alcohols of zero to approximately 35 percent to water concentrations should be utilized or added as an anti-shock agent, where there is a fairly sizable presence (i.e., above 1%) of clays in the gypsum, or in the presence of sizable clay percentages (i.e., above 0.1%) in the recycled construction board paper being utilized. The partly hydrolyzed grade PVAl's is provided in 25% solution with water, which solution in turn is present at approximately 5% to 30% by weight of the binder.

The inventor herein has recently discovered a phenomenon that occurs when polyvinyl acetate (PVA) emulsion is added to beta hemi-hydrate gypsum in the practice of the instant invention, and a solution to correct this phenomenon, as follows. When PVA is introduced into the standard construction board manufacturing apparatus, slurry thickening occurs in the pin mixer as the constituents are combined, in turn causing an increase in viscosity which creates an increased water demand to maintain or regain a proper fluidity in the slurry. The increased water demand is a problem in that more energy is required to drive off the excess moisture, and strength is also compromised. The following is an example of post addition of lower molecular weight PVAl to the PVA emulsion before introduction into the pin mixer under conventional construction board line manufacturing production in order to reduce or altogether eliminate the clay shock or thickening phenomenon. A 10% to 30% solution of PVAl and water (the specific concentration depending upon the severity of the thickening and being easily determined upon inspection during production) is mixed to batch with the PVA emulsion. The ratio of between 10% to 30% PVAl solution is between 5 and 20 parts PVAl to 80 and 95 parts of PVA emulsion, and can be blended together until a homogenous mix is obtained. The above procedure is practiced prior to the emulsion being utilized in the process of this invention, and the two constituents can be recirculated together to combine once the PVAl is placed into solution. Too much PVAl can affect strength and can cause hydration problems in the system, so the proper ratio is essential. It is particularly of note that due to the siliceous nature of some gypsum deposits, the 10% solution of PVAl may not be sufficient at 5% of the PVA to solve the thickening issue, such that higher concentrations of PVAl would be required to solve the problem. Again, the precise concentration may be easily determined upon inspection during production of the construction board of the instant invention. In addition, a small amount of Sorbitol (between 0.1% and 5%) in approximately 70% solution can act as a vehicle for the gypsum to attach to instead of attaching to the polyvinyl alcohol contained within the PVA emulsion itself. This is the purpose of post adding the lower molecular weight PVAl to the PVA emulsion, namely, to counteract the reaction causing the thickening allowing more PVAl to react with the gypsum. It is believed that the chemical reaction that occurs when PVA is added to the stucco can be countered with the post addition of the lower molecular weight PVAl. While it would be most preferable to blend the PVA with the lower molecular weight PVAl at the emulsion manufacturing site so as to be ready to use when received at the construction board manufacturing facilities, the current need of evaluating the thickness of the slurry during board production to establish the appropriate concentration requires that the two constituents be combined at the board manufacturing facility.

Thickening of the final gypsum/perlite slurry can also be corrected or further corrected through other methods. One simple solution is to utilize oxidized starch in the presence of PVAl's or PVA's. Further improvements in fluidity will occur when waxy oxidized starch is used. The type of starch used, or preferred, is discussed in other parts of this specification. Higher-grade starches will produce better reactions and strength results, and should be weighed in terms of total cost in determining the final selected and prepared PVAl and PVA copolymer or homopolymer emulsion utilized.

It was also found favorable to raise the glass transition temperature (T_{g}) of the polymer system for better fire testing results of the samples tested. A higher fire rating using VAP's would certainly be preferred in construction board applications. The T_{g} range from 28° C. to 39° C., with higher T_{g} being preferred in VAP applications, were examined during fire tests, and yet all were found acceptable. In order to obtain higher transition temperatures (T_{g}), other copolymers may be prepared and/or pre-added to the emulsion in smaller quantities, such as 2-ethyl hexylacrylate, ethyl acrylate, dibutyl fumurate, vinyl stearate, polymethyl methacrylate, or butyl methacrylate. Cost should be considered in percentages used as these will generally increase the overall modified polymer emulsion cost.

It has been discovered by the inventor herein that the selected binder can be caused to foam when mixed vigorously enough with processed water. The foamed binder can aid in aerating the board and decrease or even eliminate the need for soap foaming agents currently used to aerate construction board in manufacturing. This in turn reduces the cost of the board manufacturing process by reducing the need for soap foaming agents. It is believed that soap bubbles and soaps in general do nothing for and actually tend to diminish the strength of the ground gypsum, perlite particles and/or other dry constituents from bonding or cohering to each other and then to the board paper plies. Soaps used today do not aid in sticking or gluing particulates together but separate or repel them from doing the same. Therefore, the binder need be of proper combination and viscosity to form the proper sized bubbles and remain reasonably constant through the kiln drying process to properly aerate the finished board. Polyvinyl acetate emulsions when mixed properly with water, similar to soaps, will foam and can produce a stronger same size bubble due to their surfactant content.

The binder or emulsion can also be slightly altered in viscosity by adding other binders or foaming agents to enhance proper sized bubbles that react similarly, yet firmer, than soap bubbles. Examples of nonionic surfactants which can be useful in this invention are polyethers, e. g., ethylene oxide and propylene oxide condensates which include straight and branched chain alkyl and alkaryl polyethylene glycol and polypropylene glycol ethers and thioethers; alkylphenoxypoly (ethyleneoxy) ethanols having alkyl groups containing from about 7 to about 18 carbon atoms and having from about 4 to about 240 ethyleneoxy units, such as heptylphenoxy-poly (ethyleneoxy) ethanols, octyl-and nonylphenoxy-poly (ethyleneoxy) ethanols; the polyoxy-alkylene derivatives of hexitol (including sorbitans, sorbides, manitans and mannides); partial long chain fatty acid esters, such as the polyoxyalkylene derivatives of sorbitan monolaurate, sorbitan monopalmitate, sorbitan monostearate, sorbitan tristearate, sorbitan monooleate and sorbitan trioleate; the condensates of ethylene oxide with a hydrophobic base, said base being those formed by condensing propylene oxide with propylene glycol; sulfur containing condensates, e. g., those prepared by condensing ethylene oxide with higher alkyl mercaptans, such as nonyl, dodecyl, or tetradecyl mercaptan, or with alkylthiophenols wherein the alkyl group contains from about 6 to about 16 carbon atoms; ethylene oxide derivative of long chain carboxylic acids, such as lauric palmitic, oroleic acids or mixtures of acids, such as tall or fatty acids; and ethylene oxide derivatives of long chain alcohols such as octyl, decyl, lauryl, of cetyl alcohols.

The preferred nonionic surfactants useful to be added to the latex polymer for the purpose of dispersing the latex polymer throughout the gypsum slurry and creating a stronger bubble than can be achieved with the more commonly used wallboard foaming agents are higher (greater than C8) aliphatic alcohol alkoxylates, aliphatic acid alkoxylates, higher aromatic alcohol alkoxylates, fatty acid amides of alkanolamines, fatty acid amide alkoxylates, propylene glycol alkoxylates, block or random copolymers of ethylene and propylene oxide, higher (greater than C8) alcohol polyethylene polypropylene block or random adducts and mixtures thereof. Of the above classes of nonionic surfactants, the alcohol ethoxylates and alkaryl ethoxylates are particularly preferred. In practice, the amount of nonionic surfactant to be added to the latex polymer is about 1 to about 30 parts per 100 parts of polymer.

Additionally, the binder or emulsion can be pre-mixed with the starch in solution to further enhance or control the foaming presence. The most important difference however from just using soap foam water is that the final combined binder solution bubbles will grab onto and adhere to the gypsum, perlite or expanded mineral, and other dry ingredients in the pin mixer and then grab onto the board paper to form more bonded, firm, and therefore stronger composite construction board.

Additionally, water based non-V.O.C. acrylic or polyurethane polymer systems can be utilized as the binder in the formulation of the construction board of the present invention either alone or in combination with other polymer systems mentioned herein. The benefit of using a water based non-V.O.C. polymer system in formulating the composite core from an environmental standpoint is a polymer that is completely non-toxic to the workers who work with it as well as having no detrimental effects on the ecosystem surrounding the manufacturing plant where it is being utilized. Being water-based, the system is very compatible with the other constituents that make up the core of the gypsum construction board of the instant invention. The non-V.O.C. polymer system is completely biodegradable and safe to the environment as opposed to petrochemical polymers and worked as well as or better than many of the petrochemical based polymers tested.

In addition to using water based non-V.O.C. acrylic or polyurethane polymer systems, a blend of organic and inorganic polymers in an alternate embodiment of the instant invention likewise provides superior adhesion and cohesion properties. More particularly, polyvinyl acetate or polyvinyl alcohol and an organic polymer selected from the group consisting of aniline formaldehyde resin, melamine formaldehyde resin, urea-formaldehyde resin, and urea-melamine formaldehyde resin will crosslink with one another in the presence of formaldehyde and a borate ion. When such organic polymers are added to the construction board composition of the instant invention, reactions occur that form the blended polymer into a three dimensional molecular structure completely crosslinking with the inorganic minerals of the system to form a strengthened composite construction board core. Such core construction has been found to provide a construction board with increased flexibility and strength over prior known construction board compositions, such that the board may readily withstand construction movement and installation stresses, particularly when compared to prior construction board compositions comprising starch as an adhesive with paper fibers or fiberglass fibers added for attempted increased flexibility and strength. Moreover, the use of such a blended polymer composition adds fluidity and reduces cost in the manufacture of the construction board.

The above-noted amino resins have characteristics that are favorable to construction board applications, such as being self-extinguishing, resistant to oil, grease, acid, and organic solvents, easy to fabricate, thermosetting, and exhibiting good rigidity and excellent deformation under stress loading. A cellulose filler may be added to such amino resins in combination with the vinyl acetate and polyvinyl alcohol as discussed at length above to further reduce cost and reduce light transmission.

In use, the selected amino resins are added in up to 99 parts per 100 parts of the polyvinyl acetate/polyvinyl alcohol in order to increase the initial set strength of the polymer. Preferred aqueous solutions of the above-noted amino resins consist of 55% to 70% solids. The cited amino resins are preferably blended with the polyvinyl acetate in a range from about 40:60 to about 60:40. However, other proportions will also work, with the ultimate blend range of polyvinyl acetate to amino resin depending upon the purity of the gypsum plaster, and what other components are present, such as clay or limestone. The more pure or close to 100% purity the gypsum stucco is, the less amount of polyvinyl acetate will be required to achieve sufficient strength development.

A compatible fire retardant, such as boric acid, zinc borate, sulfamates, diammonium phosphate, nitrogen compounds, antimony oxide, silica, titanium oxide, zircon and others can be used and comprise from about 0.15 percent to about 3 percent by weight of the board. These fire retardants can be added to the formulation by powder or solution during the slurry mixing process, and also by spraying onto the paper covering for the purpose of fire retarding the laminate covering paper of the construction board. The examples of applying fire retardants are listed as follows:

EXAMPLE 1 (Fire retardant, moisture resistant system): this system sprays fire retardant solutions directly onto the board as it leaves the cascade sections and enters the take off area of the manufacturing equipment. This is accomplished by using spray heads overhead together with switch activators to trigger the action as the board passes by on the conveyor. Additives are supplied by storage tanks and pressure type discharge systems. The additives are sprayed directly on the face paper.

EXAMPLE 2 (Fire Retardant): another way to apply a fire retardant quality to the paper is to add it in dry form during the Krafting process of the paper's manufacture. Small particle distribution of fire retardant are added to the pulp slurry prior to extrusion into the paperboard. This allows for the fire retardant to be completely integrated into the paper. This fire retardant could be zinc borate, antimony oxide, nitrogen compounds or sulfamates (sulfur compounds). These are all common fire retardants in paper.

Fire Retardant additives to the adhesives, such as the addition of boric acid, reduce the overall flash point of these chemicals and therefore increase the fire rating of the core composite. Under fire rating test samples, the presence of noxious fumes were greatly reduced even to the point of being virtually eliminated as the samples moved away from the epoxies and non-water solvent adhesive mixtures. The combination of vinyl acetates with cementious materials also provided a good fire retardant combination without the addition of boric acid.

Optionally, an improved construction board cover material consists of a manila colored moisture resistant paper face sheet in the range of 40-50 pounds with an altered top ply. In traditional construction board structures incorporating a cover material composed of recycled paper pulp, the length of fibers in the cover material is between ½ and ¾ inches. The instant invention, however, employs a top ply sheet composed of virgin fibers of 1 inch or greater. While papers incorporating fiber lengths of greater than 1 inch have been produced in the past, to the best of the inventor's knowledge, no such virgin pulp has been applied previously to the top ply cover sheet of a construction board sheet. Thus, the inclusion of such extended length fibers into the construction board cover sheet of the instant invention provides the unforeseen and unobvious benefit of providing a much stronger break strength than previously known construction board structures.

The unique application of the optional spec paper cover sheets of the construction board of the present invention is completely formed by any well known paper forming process. Using 100 percent “virgin stocks” for the top ply of the face paper cover sheet allows for predictable liner strength while also eliminating some of the clays and fillers associated with current completely recycled construction board paper. By integrating a virgin pulp top ply with existing recycled construction board paper plies, increased strength and wet handling characteristics are achieved. First, a paper cover sheet is made generally comprising a multiply sheet manufactured on a cylinder machine. Conventional sizing compounds are added to selected vats such as rosin and alum to internally size some or all plies. The plies are removed and laminated to form an essentially unitary web of paper. After being dried, the paper is coated with a water emulsion of the synthetic size of the class consisting of certain substituted succinic acid anhydrides, certain substituted glutaric acid anhydrides and the reaction product of maleic acid anhydrides with an internal olefin. This process allows for effective absorption into the bond liner of the core side of the paper to provide a mechanical linking of the paper to the composite core.

Alternately, a cover sheet may be utilized comprising a combination of non-wood type or organic fibers such as Kenaf with or without recycled waste paper wood pulp fibers. Utilizing a completely or partially tree-free pulp creates a construction board having a more environmentally friendly cover sheet than traditional construction board products. Typically, recycled wood pulp fibers are shorter in length, by up to half, over their virgin pulp counterparts, and the strength that papers manufactured with virgin pulp fibers achieve cannot be duplicated with recycled fibers. However, papers manufactured with virgin wood pulp fibers are much more costly when compared to the cost of papers manufactured with the recycled wood waste pulp variety. By integrating stronger non-wood type organic fibers into the recycled wood waste pulp during the paper manufacturing process, a much thinner but stronger paper cover sheet is realized, allowing the construction board of the instant invention to more easily meet ASTM and Building Code requirements when very lightweight core formulations are being utilized. The weight percentage of fiber of a source other than wood can vary from 1 to 100 percent of the pulp formulation depending upon the desired end result.

As yet another alternative, the paper cover sheets of the construction board of the instant invention may be reinforced using fiberglass mesh material integrated between the inner face liner of the paper cover sheet and the remaining laminates to produce highly abuse-resistant lightweight construction boards. When utilizing formulations to produce construction boards with densities at under 30 pcf (pounds per cubic foot), flexural strength can be reduced significantly in the core. By integrating a fiberglass mesh material beneath the inner surface laminate of the paper facer, flexural or paper grain strength can be retained well above ASTM utilizing slurry formulations to produce abuse-resistant construction boards of the instant invention as low as 25 pcf density. As paper is the majority of the strength of gypsum construction board, this fiberglass mesh material also strengthens sheer panel strength of the invention when utilizing lightweight construction board core formulations of the instant invention. The paper facers utilized in the production of gypsum construction board are normally made on cylinder machines from recycled paper in order to produce a porous paper capable of receiving the gypsum crystals that grow from the wet core slurry prior to drying. The placement or integration of the fibers between the inner liner face of the cover sheet and the remaining laminate layers can be achieved during the paper manufacturing process after the paper is formed into a fibrous web from the pulping process. The introduction of a non-woven fiber mesh into the papermaking process is achieved through placement of the mesh between the fibrous sheets during the laminating process, before dewatering. The same sizing compounds can be utilized and the porous properties of the paper remain the same. The fiberglass material or mesh can be oriented in a variety of crisscross patterns or evenly spaced shapes. Optionally, the mesh can be interlinked similar to a chain link fence within the inner laminate of the facer sheet to further increase its strength. The paper facers will still maintain their ability to absorb the slurry and the properties of the fiberglass will be such that the gypsum crystal can also mechanically link to the fiberglass strands as well. The fiberglass strands can be of various lengths, with the preferred length being 2 inches or greater. The fibers will increase the flexural and racking loads that the wallboard will be able to withstand both during construction and also once the structure is completed. The fiber integration will greatly increase the abuse resistance of the construction board while maintaining lighter weights when compared to abuse resistant boards currently on the market.

Even further, the inner liner of the facer sheets can be subjected to an abrasive during the manufacturing process to provide a rough finish, to in turn allow for an improved bonding between the stratum of the gypsum core and the facer sheets. The roughed up liner surface of the facer sheets causes an improved surface for the gypsum slurry crystal growth to adhere with in contrast to the very smooth surfaces found on gypsum wallboard paper facers commonly utilized.

If bituminous or waxy water-repellent materials are used, they comprise from about 1.0 percent to about 10 percent of the Perlite weight by volume. These materials may be applied to the Perlite from molten states or as emulsions. If silicone emulsions are used, the silicone comprises from about 0.01 to about 2 percent of the Perlite by weight. The silicone emulsions may be applied directly to the Perlite as it exits the expander by means well known in the art.

### EXAMPLES

The following examples employing the instant invention proved to bring very favorable test results.

EXAMPLE 1

The following is an example of post addition of polyvinyl alcohol to the formulation of the instant invention. A 6 inch by 6 inch by ½ inch sample is prepared using the following formulation:

| | Weight in | Weight by | |
|---|---|---|---|
| Materials | Ounces | Percentage | Preferred |
| Gypsum | 5.80 | 42-50% | 45.224% |
| Perlite | 0.30 | 1-3% | 2.339% |
| Board Starch | 0.05 | 0.3-0.6% | 0.389% |
| Accelerator | 0.03 | 0.1-0.3% | 0.233% |
| Boric Acid | 0.01 | 0.01-0.15% | 0.077% |
| Vinyl Acetate | 0.30 | 0.8-4% | 2.339% |
| Polyvinyl Alcohol | 0.035 | 0.1-0.3% | 0.272% |
| Lignosite (dispersant) | 0.10 | 0.07-0.8% | 0.779% |
| Ethoxysulfate (soap) | 0.10 | 0.07-0.8% | 0.779% |
| Water | 6.10 | 42-48% | 47.569% |

First, the dry constituents, gypsum, perlite, board starch, accelerator, and boric acid are blended until a homogenous mixture is obtained. Next, in a separate vessel, the vinyl acetate and polyvinyl alcohol and dispersant are mixed together with ⅔ of the total water and the remaining ⅓ of the total water is combined with the soap foaming agent and blended to achieve ¼ inch diameter bubbles of foam. Finally, all of the constituents are combined in a laboratory mixer and blended until 100% of a slurry is obtained. The slurry is then poured into a paper envelope comprising fire resistant and water repellant construction board cover sheets and formed and sealed. After hydration occurs, the sample is placed into a small laboratory kiln to drive off the excess water and dry the board example. The test results for this composition passed ASTM C36 specification.

### EXAMPLE 2

It has been found that sodium trimetaphosphate may be utilized to increase compressive strength by enhancing cylindrical needle-like crystal growth in the core of the improved strengthened construction board of the instant invention. Sodium trimetaphosphate is a combination of earth metals and is known by the chemical equation (NaPO₃)₃. This compound may be added to the slurry either in solution or in a dry powder state, although in solution is preferred. By adding sodium trimetaphosphate into the system, the favorable long cylindrical crystal growth that adds the most strength to the core of the construction board and also enhances the paper to core bond is greatly increased, and the result is higher compressive strength. The compound is highly water soluble and dilutes very quickly allowing it to disperse very rapidly. The resultant chemical reaction is not entirely understood, although it is believed that the sodium hydroxide and fluoride in the sodium trimetaphosphate reacts with the calcium in the gypsum and increases the crystal growth. The following is an example of the addition of sodium trimetaphosphate to the formulation of the instant invention. A 6 inch by 6 inch by ½ inch sample is prepared using the following formulation:

| | Weight in | Weight by | |
|---|---|---|---|
| Materials | Ounces | Percentage | Preferred |
| Gypsum | 6.70 | 42-50% | 47.857% |
| Perlite | 0.25 | 1-3% | 1.785% |
| Board Starch | 0.05 | 0.3-0.6% | 0.357% |
| Ball Mill Accelerator (bma) | 0.02 | 0.1-0.3% | 0.142% |
| Boric Acid | 0.005 | 0.01-0.15% | 0.035% |
| Vinyl Acetate | 0.15 | 0.8-4% | 1.071% |
| Polyvinyl Alcohol | 0.03 | 0.1-0.3% | 0.214% |
| Sodium Trimetaphosphate | 0.095 | 0.01-0.7% | 0.678% |
| Ethoxysulfate (soap) | 0.10 | 0.07-0.8% | 0.714% |
| Lignosite (dispersant) | 0.10 | 0.07-0.8% | 0.714% |
| Water | 6.50 | 42-48% | 46.433% |

First, the dry constituents, gypsum, Perlite, board starch, bma, and boric acid are blended until a homogenous mixture is obtained. Next, in a separate vessel, the vinyl acetate and polyvinyl alcohol and dispersant are mixed together with ⅔ of the total water and the remaining ⅓ of the total water is combined with the soap foaming agent and the sodium trimetaphosphate and blended to achieve ¼ inch diameter bubbles of foam. Finally, all the constituents are combined in a laboratory mixer and blended until 100% of a slurry is obtained. The slurry is then poured into a paper envelope comprising fire resistant and water repellant construction board cover sheets and formed and sealed. After hydration occurs the sample is placed into a small laboratory kiln to drive off the excess water and dry the board sample. The test results for this composition satisfied the criteria of ASTM methods C-36 and C-473.

### EXAMPLE 3

| | Weight in | Weight | |
|---|---|---|---|
| Materials | pounds per MSF | by % | Preferred |
| Perlite | 60 | 1-3% | 2.564% |
| Calcined gypsum | 1130 | 42-50% | 48.295% |
| Ball mill accelerator | 7.0 | 0.1-0.3% | .299% |
| Starch | 9.0 | 0.3-0.6% | .384% |
| Boric Acid | .25 | 0.01-0.15% | .015% |
| Sodium Trimetaphosphate | .50 | 0.01-0.7% | .021% |
| Fiberglass fibers | 1.5 | 0.1-0.2% | .064% |
| Dispersant (lignosulfonate) | 2.0 | 0.07-0.8% | .085% |
| Soap (foamer) | 1.5 | 0.07-0.8% | .064% |
| Vinyl Acetate | 28.0 | 0.8-4% | 1.196% |
| Water | 1100 | 42-48% | 47.013% |

This example discloses a composition reflecting the most preferred embodiment of the improved construction board composition of the instant invention, and continues the study of the addition of various percentages of calcium sulfate into the composite core. It is also a test of an adhesive formulation comprising vinyl acetate polymer emulsion, modified starch, and boric acid. In this test, the first step was to mix about 15% of the preferred Perlite of the invention with the remaining dry constituents. The Perlite 15% (by volume) was combined with modified starch, ball mill accelerator, boric acid, and about 25% (by volume) calcium sulfate. Next, about 5% (by volume) vinyl acetate emulsion was added to soap foam, dispersant and about 50% (by volume) water. The wet and dry ingredients are fed by normal board manufacturing line apparatus into a pin mixer for 3 seconds. The slurry is dispersed onto continuous moving paper cover sheets. The construction board is formed and conveyed to the cutting knife. The board set up fairly hard in under three minutes and was then cut to desired lengths. The board was then inverted and run through a kiln at normal drying temperature parameters for about an hour. Once cooled, the sample was weighed and measured and the results were catalogued. Several days later this sample was conditioned and then tested to ASTM C473 standards. Test results confirmed nearly double those of the gypsum core control sample in nail pull resistance, edge hardness, and with improved flexural strength. EXAMPLE 4

| | Weight in | Weight | |
|---|---|---|---|
| Materials | Ounces | by % | Preferred |
| Gypsum | 10.0 | 48-55% | 51.355% |
| Ball Mill Accelerator | .05 | 0.1-0.3% | .244% |
| Starch | .08 | 0.3-0.6% | .387% |
| Boric Acid | .02 | 0.01-0.15% | .096% |
| Potassium sulfate | .01 | 0.05-0.3% | .048% |
| Lignosulfonate (dispersant) | .01 | 0.07-0.8% | .048% |
| Soap (foamer) | .02 | 0.07-0.8% | .096% |
| Vinyl Acetate | .35 | 0.8-4% | 1.697% |
| Water | 9.5 | 42-48% | 46.029% |

This example discloses the addition of the unique adhesive formulation of the instant invention into traditional gypsum board without an expanded mineral added. Calcium sulfate(gypsum), starch, ball mill accelerator, potassium sulfate, and boric acid were combined in the above amounts. Then, lignosulfonate, Ethoxysulfate, vinyl acetate, and water were combined and mixed into a foamy consistency and combined with the dry ingredients. The mixture was mixed at high speed and then poured into a 6″ by 12″ form with a construction board paper insert and sealed and formed into a sheet identical to traditional gypsum board. The sample was then removed from the form and the set was timed. After timing the set and allowing the full hydration set to occur, the sample was then heated in a kiln at 180° F. to evaporate excess water. Once dry, these boards were left to cure for two days and then tested. These experiments were conducted to evaluate increased strength in traditional construction board compositions with the addition of the synthetic binder. Nail pull resistance, edge hardness, and flexural strength were increased 150% in all the samples that were made and tested. This decrease in set time and increase in strength of the construction board can allow for increased operating speeds in current board manufacturing facilities. Varying curing temperatures were applied in this example from 75° C. to 352° C. with favorable test results, including passing nail pull resistance, flexural breaking loads, edge hardness, and humidified bond according to ASTM C36. However, the preferred curing temperatures ranged from 79° C. to 275° C.

### EXAMPLE 5

| | Weight in | Weight | |
|---|---|---|---|
| Materials | Ounces | by % | Preferred |
| Perlite | .40 | 1-3% | 2.366% |
| Gypsum | 8.0 | 42-50% | 47.281% |
| Ball mill accelerator | .04 | 0.1-0.3% | .238% |
| Starch | .07 | 0.3-0.6% | .413% |
| Boric acid | .015 | 0.01-0.15% | .088% |
| Potassium sulfate | .015 | 0.05-0.3% | .088% |
| Dispersant | .02 | 0.07-0.8% | .118% |
| Soap (foamer) | .01 | 0.07-0.8%‘ | .059% |
| Vinyl Acetate | .35 | 0.8-4% | 2.068% |
| Water | 8.0 | 42-48% | 47.281% |

In this example, first the dry ingredients were combined together and blended until a homogeneous mix was achieved, these dry ingredients being plaster grade expanded perlite with a loose density of 6 to 8 pounds per cubic foot, calcined gypsum stucco, starch, ball mill land plaster accelerator, pot ash and boric acid. Secondly, the dry lignosite dispersant was combined with the water and mixed until blended. Thirdly, the soap water and vinyl acetate were combined together and blended with an electric mixer to generate foam or bubbles. The soap water and vinyl acetate foam mix was then added to the lignosite and water and then all the wet ingredients were combined with the dry blended ingredients and mixed by hand for about 15 seconds to achieve 100% of a slurry. The ambient temperature was 82° F. and the surrounding humidity was 29%. This slurry was then poured into a fire resistant and water repellant construction board paper insert or envelope to make a ½ inch thick board sample measuring 6 inches by 6 inches. The back sheet of the insert was then sealed to the face sheet folds using a starch based drywall edge paste, formed, and then removed from the form, and the initial or snap set was timed and recorded. In a typical drywall manufacturing process there are two different sets, first being the initial or snap set, whereas the continuous board hardens or stiffens sufficiently to be cut into desired lengths downstream at the rotary knife. The secondary or hydration set relates to the complete hydration of the gypsum crystals, meaning the amount of time sufficient to rehydrate the calcined gypsum, replacing the two molecules of H₂O removed during the calcining process of land plaster. This secondary hydration set can be from as low as 4.6 minutes to as high as 7 minutes depending on the grind and purity of the land plaster being utilized. At 2 ½ minutes the sample of the above example was cut cleanly and inspected. The inspection revealed that the slurry had sufficiently set and it is believed that the chemical reaction of the synthetic binder (vinyl acetate) and the calcined gypsum allows the gypsum crystal to rehydrate more rapidly than calcined gypsum rehydrated without the synthetic additive of the present invention. The above process has been duplicated repeatedly in the lab with slight variations in formula achieving the same results. A range of volumes of the preferred synthetic binder (vinyl acetate) were tested with gypsum and consistently set times were reduced over those of the gypsum control samples with no synthetic additives, and consistently stronger samples were obtained over those of the gypsum control samples with no synthetic additives. All procedures including the drying of the samples were consistent with typical drywall manufacturing processes. The excess water in the samples was driven off by placing samples in a laboratory kiln with access to moving heated air at a temperature of between 150° C. and 200° C. for a period of 50 minutes to 1 hour.

### EXAMPLE 6

| | Weight in | Weight | |
|---|---|---|---|
| Materials | Ounces | by % | Preferred |
| Perlite | .30 | 1-3% | 1.816 |
| Gypsum | 8.0 | 42-50% | 48.434 |
| Starch | .075 | 0.3-0.6% | .454 |
| Ball mill accelerator | .037 | 0.1-0.3% | .224 |
| Boric acid | .015 | 0.01-0.15% | .090 |
| Dispersant | .020 | 0.07-0.8% | .121 |
| Soap (foamer) | .020 | 0.07-0.8% | .121 |
| Non-V.O.C. acrylic polymer | .35 | 0.8-4% | 2.119 |
| Water | 7.7 | 42-48% | 46.618 |

This example discloses the other preferred unique adhesive formulation of the instant invention into traditional gypsum board. Calcium sulfate(gypsum), starch, ball mill accelerator, and boric acid were combined in the above amounts. Then, lignosulfonate, Ethoxysulfate, non-V.O.C. acrylic emulsion, and water were combined and mixed thoroughly and was then combined with the dry ingredients. The mixture was mixed at high speed and then poured into a 6″ by 12″ form with a construction board paper insert and sealed and formed into a sheet identical to traditional gypsum board. The sample was then removed from the form and the set was timed. After timing the set and allowing the fall hydration set to occur, the sample was then heated in a kiln at 180° F. to evaporate excess water. Once dry, these boards were left to cure for two days and then tested. These experiments were conducted to evaluate increased strength in traditional construction board compositions with the addition of the synthetic binder. The resulting board samples of this particular example surpassed all ASTM C36 specifications. The test results for this composition satisfied the criteria of ASTM methods C-36 and C-473.

### EXAMPLE 7

| | Weight in | Weight | |
|---|---|---|---|
| Materials | Ounces | by % | Preferred |
| Gypsum | 990.0 | 42-50% | 48.072% |
| Expanded Perlite | 50.0 | 1-3% | 2.427% |
| Starch | 10.0 | 0.3-0.6% | 0.485% |
| Ball mill accelerator | 4.0 | 0.1-0.3% | 0.194% |
| Potassium sulfate | 2.75 | 0.134% | 0.05-0.3% |
| Boric acid | 0.25 | 0.01-0.15% | 0.013% |
| Foaming Agent | 1.50 | 0.07-0.8% | 0.073% |
| Sodium Trimetaphosphate | 0.50 | 0.01-0.7% | 0.024% |
| Ethoxilated Alcohol | 0.40 | 0.01-0.7% | 0.019% |
| Vinyl Acetate Emulsion | 28.0 | 0.8-4% | 1.359% |
| Diloflo (Naphthalene Sulfonate) | 2.0 | 0.07-0.8% | 0.099% |
| Water | 970.0 | 42-49% | 47.101% |

This example discloses the addition of a straight chain linear ethoxilated alcohol, added to the synthetic binder in a blend prior to its introduction into the system of this invention. By adding the nonionic surfactant to the binder, the polymer has greater dispersion capabilities in the slurry and forms strong or strengthened air entrainment into the matrix. The wetting action of the nonionic surfactant when blended with the polymer also decreases the amount of water needed to achieve a workable slurry. This example exemplifies the most preferred formulation of this invention. The system as a whole will achieve construction board weights up to 40 percent lighter and meets all ASTM standards for C36 gypsum wallboard specifications. This formulation is for use in production runs of the invention and is measured in units per thousand square feet typical to industry practice. The dry ingredients are fed into a mixing conveyor screw from their respective feeders and blended while being conveyed to the pin mixer. The wet ingredients, with the exception of the foam, are blended and fed into the water system upstream of the pin mixer to achieve proper dispersion. The formed construction board is then conveyed on a belt to the knife during which time it has set to a hardness sufficient to be cut at the knife. After being cut into the desired lengths it is inverted and run through a multi deck board drying kiln. The resulting dry construction board is stacked and housed for shipment to consumers. All of the construction board of this example met or exceeded nail pull resistance, flexural breaking loads, core and edge hardness, and deflection as well as humidified bond requirements per ASTM C36.

The following three examples set forth the use of amino resins as described above, and result in a construction board composition which exhibits increased nail pull, initial set, and fluidity in the presence of clay. Likewise, lesser amounts of the overall polymer are required due to the initial strength development of the core using the formulations set forth below.

### EXAMPLE 8

| | Weight in | Weight | |
|---|---|---|---|
| Materials | Pounds/MSF | by % | Preferred |
| Gypsum | 1042 pounds/MSF | 46-50% | 49.431% |
| Perlite | 35 pounds/MSF | 1-2% | 1.660% |
| Starch | 8 pounds/MSF | .2-.5% | .380% |
| Accelerator | 3 pounds/MSF | .1-.3% | .142% |
| Fiberglass | 2 pounds/MSF | .05-.1% | .095% |
| Boric Acid | 1 pound/MSF | .04-.1% | .047% |
| Vinyl Acetate | 10 pounds/MSF | .4-1% | .474% |
| Melamine resin | 20 pounds/MSF | .5-1.5% | .949% |
| Foam agent | 2 pounds/MSF | .05-.1% | .095% |
| Naphthalene Sulfonate | 5 pounds/MSF | .1-.3% | .237% |
| (Wetting Agent) | | | |
| Water | 980 pounds/MSF | 44-47% | 46.490% |

### EXAMPLE 9:

| | Weight in | Weight | |
|---|---|---|---|
| Materials | Pounds/MSF | by % | Preferred |
| Gypsum | 972 pounds MSF | 46-50% | 49.041% |
| Perlite | 55 pounds MSF | 1-3% | 2.775% |
| Starch | 9 pounds MSF | .2-.5% | .454% |
| Accelerator | 7 pounds MSF | .2-.5% | .252% |
| Pulp fiber | 3 pounds MSF | .05-.2% | .151% |
| Boric Acid | 4 pounds MSF | .1-.3% | .202% |
| Aniline-Formaldehyde- | 19 pounds MSF | .5-1.5% | .958% |
| Resin | | | |
| Vinyl Acetate- | 6 pounds MSF | .3-.6% | .303% |
| Emulsion | | | |
| Foam Agent | 4 pounds MSF | .1-.3% | .202% |
| Lignin | 3 pounds MSF | .05-.2% | .151% |
| White Dextrin | 2 pounds MSF | .07-1.2% | .101% |
| Water | 900 pounds MSF | 44-48% | 45.409% |

### EXAMPLE 10:

| | Weight in | Weight | |
|---|---|---|---|
| Materials | Pounds/MSF | by % | Preferred |
| Gypsum | 1050 pounds MSF | 46-50% | 49.065% |
| Perlite | 35 pounds MSF | 1-2% | 1.635% |
| Starch | 8 pounds MSF | .2-.5% | .373% |
| Accelerator | 5 pounds MSF | .1-.3% | .233% |
| Fiberglass | 2 pounds MSF | .05-.1% | .093% |
| Boric Acid | 1 pound MSF | .05-.1% | .046% |
| Vinyl Acetate | 15 pounds MSF | .5-1.5% | .704% |
| Urea Resin | 15 pounds MSF | .5-1.5% | .704% |
| Foam agent | 2 pounds MSF | .05-.1% | .093% |
| Naplithalene | 5 pounds MSF | .1-.3% | .233% |
| (Wetting Agent) | | | |
| Dextrose | 2 pounds MSF | .05-.1% | .093% |
| Water | 1000 pounds MSF | 44-47% | 46.728% |

I claim:

1. A composition suitable for use in the manufacture of construction board comprising:
a dry powder mineral substrate selected from the group of minerals consisting of calcium sulfate, perlite, and combinations thereof; and
a synthetic binder, said synthetic binder comprising starch, a boron source, and a blend of a first polymer and an amino resin, said first polymer being selected from the group consisting of polyvinyl acetate and polyvinyl alcohol.

2. The composition of claim 1, wherein said amino resin is selected from the group consisting of aniline formaldehyde resin, melamine formaldehyde resin, urea-formaldehyde resin, and urea-melamine formaldehyde resin.

3. The composition of claim 1, wherein said first polymer and said amino resin are present in said composition in proportion to one another ranging from 40:60 to 60:40.

4. The composition of claim 1, wherein said amino resin comprises an aqueous solution having from 55% to 70% solids.

5. The composition of claim 1, wherein said amino resin is present in said composition in an amount of about 0.5% to about 1.5% of the total wet weight of the slurry, and said first polymer is present in said composition in an amount of about 0.3% to about 1.5% of the total wet weight of the slurry.
